(19) United States
(12) Patent Application Publication
(10) Pub. No.: US 2013/0088409 A1
(43) Pub. Date: Apr. 11, 2013

(54) REFLECTOR ASSEMBLY FOR SATELLITE ANTENNA AND MANUFACTURING METHOD THEREOF

(71) Applicant: Min Son Son, Hwaseong-si (KR)

(72) Inventor: Min Son Son, Hwaseong-si (KR)

(73) Assignee: INTELLIAN TECHNOLOGIES INC., Pyeongtaek-si (KR)

(21) Appl. No.: 13/703,656

(22) PCT Filed: Apr. 20, 2011
(86) PCT No.: PCT/KR2011/002823

§ 371 Date: Dec. 12, 2012

(30) Foreign Application Priority Data
Jun. 15, 2010 (KR) 10-2010-0056297

(51) Int. Cl. H01Q 15/14; H01Q 15/16

(52) U.S. Cl. CPC H01Q 15/14; H01Q 15/16; H01Q 15/141
USPC 343/912; 29/600

(57) ABSTRACT

Disclosed herein is a reflector assembly for satellite antenna according to an exemplary embodiment of the present invention, including: a reflector having a parabola shape and made of a first material; and a reinforcing member disposed at an edge of the reflector in a circumferential direction of the reflector and made of a second material, wherein the reflector includes a bend part formed by bending an edge of the reflector so as to enclose the reinforcing member to couple the reinforcing member to the reflector. According to the present invention, it is to provide a reflector assembly for a satellite antenna capable of increasing rigidity of the reflector maintaining lightness and improving efficiency of manufacturing process and productivity.

### TECHNICAL FIELD

The present invention relates to a reflector assembly for a satellite antenna and a manufacturing method thereof, and more particularly, to a structure for improving rigidity of a reflector having a parabola shape.

### BACKGROUND ART

Generally, a satellite antenna has been used for satellite communication, large capacity wireless communication, or the like. For example, the satellite antenna is installed to a transportation means such as a ship, an airplane, or the like, and is used to transmit and receive a satellite signal, or the like, during movement.

As a representative example of the reflector antenna, there is a reflector antenna including a reflector having a parabola shape. The reflector antenna focuses transmitted and received signals on at least one focus using the reflector and includes a horn antenna or a feed horn installed on a focus position of the reflector.

Meanwhile, the reflector is typically made of an aluminum material, or the like, that is light and has excellent plastic workability in view of lightness and workability. However, in the reflector made of the aluminum material, or the like, rigidity against external impact is not sufficiently secured due to characteristics of the aluminum material. Therefore, in the case in which stress is applied to the reflector due to the external impact, or the like, the reflector may be easily deformed, which deteriorates performance of the reflector antenna. Meanwhile, in the case in which the entire reflector is made of a material having high rigidity, weight thereof is excessively increased.

Accordingly, there is a need for the development of a reflector assembly capable of improving rigidity against a reflector due to external impact, or the like, in spite of maintaining the reflector in a light state and a method thereof.

### DISCLOSURE

### Technical Problem

An object to the present invention is to provide a reflector assembly for satellite antenna capable of improving rigidity against a reflector due to external impact, or the like, in spite of maintaining the reflector in a light state, and improving efficiency of a manufacturing process and productivity, and a manufacturing method thereof.

### Technical Solution

There is provided a reflector assembly for a satellite antenna including: a reflector having a parabola shape and made of a first material; and a reinforcing member disposed at an edge of the reflector in a circumferential direction of the reflector and made of a second material, wherein the reflector includes a bend part formed by bending an edge of the reflector so as to enclose the reinforcing member to couple the reinforcing member to the reflector.

The second material may have rigidity higher than that of the first material.

The first material may be aluminum, and the second material is stainless steel.

The reinforcing member may be prepared by molding a pipe having a circular cross-section in a ring shape.

The reinforcing member may be formed of a pipe having a ring shape, the pipe being provided with a flat part extended in the circumferential direction.

The bend part may fix the reinforcing member to the reflector in a clamping scheme.

The present invention has been made in an effort to provide a manufacturing method of a reflector assembly for a satellite antenna including: (a) preparing a reflector having a parabola shape; (b) preparing a reinforcing member in order to improve rigidity of the reflector; (c) disposing the reinforcing member at an edge of the reflector; and (d) forming a bend part enclosing the reinforcing member by bending the edge of the reflector so as to couple the reinforcing member to the reflector.

In step (b), the reinforcing member may be prepared by molding a pipe having a circular cross-section.

In step (b), the reinforcing member may be formed of a pipe having a ring shape, the pipe being provided with a flat part extended in a circumference direction and formed by press processing.

In step (d), the bend part may be formed in the circumference direction of the reflector by bending the edge of the reflector outwardly by spinning processing.

The reflector may be made of an aluminum material, and the reinforcing member may be made of stainless steel having rigidity higher than that of the reflector

### Advantageous Effects

As set forth above, according to the exemplary embodiments of the present invention, since rigidity of a reflector can be improved without increasing weight of the reflector is not increased (that is, maintaining lightness) by coupling the reinforcing member to an edge of the reflector in the circumferential direction of the reflector, deformation of the reflector caused by stress applied to the reflector due to external impact, or the like may be prevented. Also, according to the exemplary embodiments of the present invention, a bend part is formed at the edge of the reflector and a reinforcing member is coupled to the reflector in a structure which it is enclosed by the bend part, thereby making it possible to further increase the rigidity of the reflector. In this case, since a welding process, or the like, for bonding the reinforcing member to the reflector is not required, efficiency and productivity of a manufacturing process may be improved.

### DESCRIPTION OF DRAWINGS

FIG. 1 is a perspective view of a reflector assembly for a satellite antenna according to an exemplary embodiment of the present invention.

FIG. 2 is a front view of the reflector assembly for a satellite antenna of FIG. 1.

FIG. 3 is a rear view of the reflector assembly for a satellite antenna of FIG. 1.

FIG. 4 is a side view of the reflector assembly for a satellite antenna of FIG. 1.

FIG. 5 is a side cross-sectional view of the reflector assembly for a satellite antenna of FIG. 1.

FIG. 6 is a perspective view of a reinforcing member of the reflector assembly for a satellite antenna of FIG. 1.

FIG. 7 is a side cross-sectional view of the reflector assembly for a satellite antenna according to another embodiment of the present invention.

FIG. 8 is a flow chart for describing an example of a manufacturing method of the reflector assembly for a satellite antenna of FIG. 1.

FIG. 9 is a view schematically showing a process for manufacturing a reflector assembly for a satellite antenna of FIG. 1.

### MODE FOR INVENTION

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

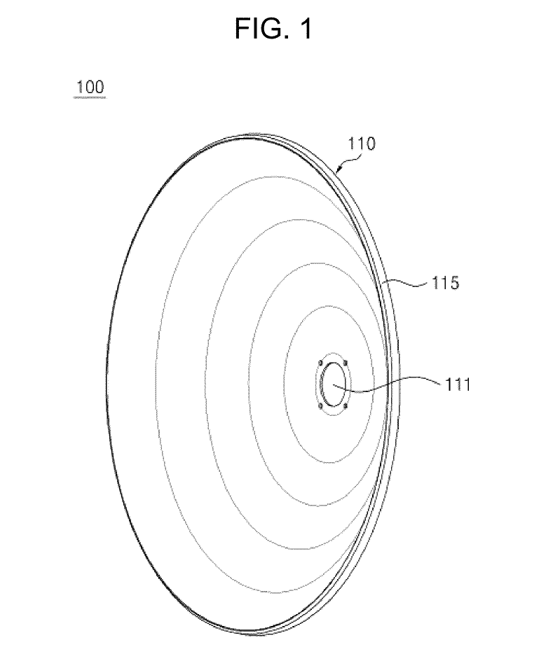

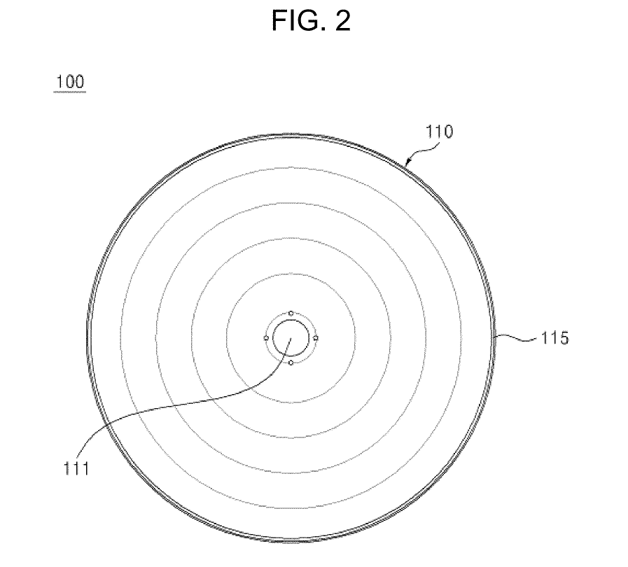

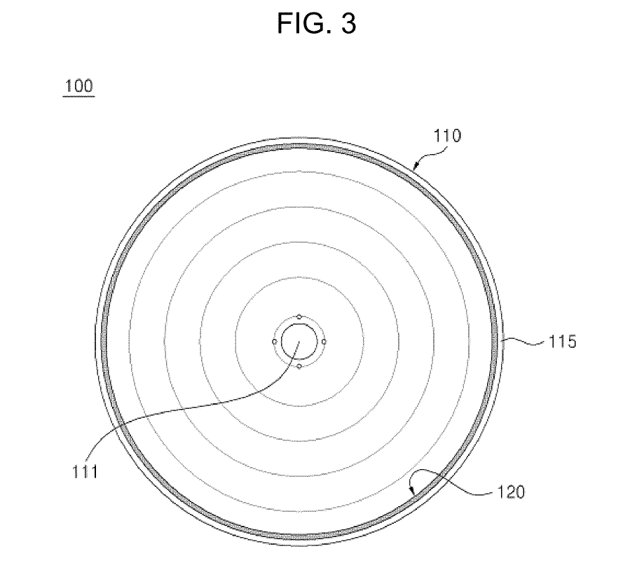

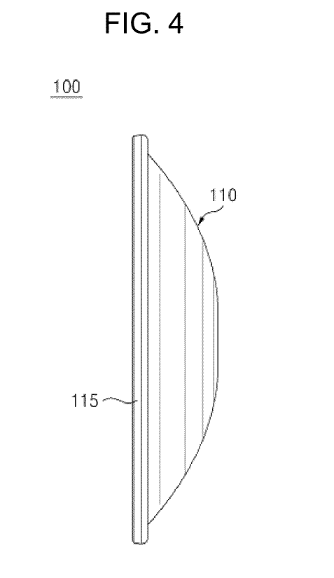

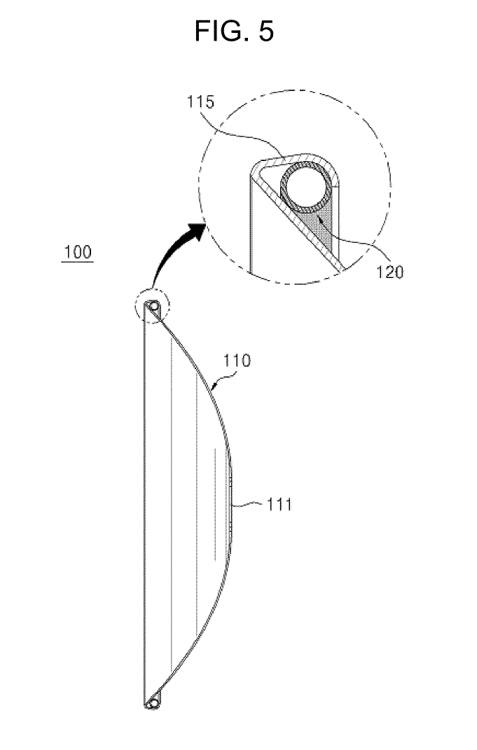

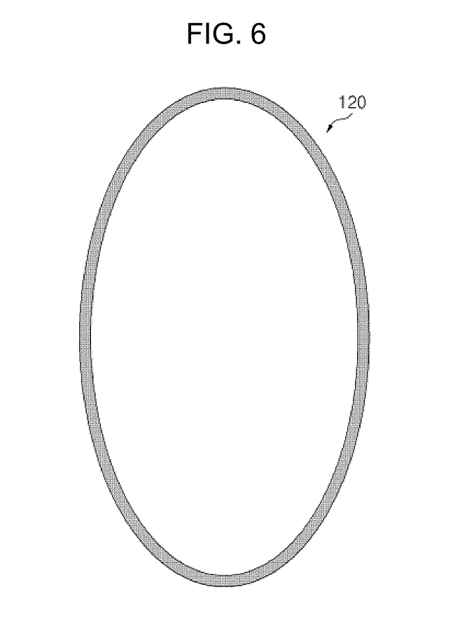

FIG. 1 is a perspective view of a reflector assembly for a satellite antenna according to an embodiment of the present invention, FIG. 2 is a front view of the reflector assembly for a satellite antenna of FIG. 1, FIG. 3 is a rear view of the reflector assembly for a satellite antenna of FIG. 1, FIG. 4 is a side view of the reflector assembly for a satellite antenna of FIG. 1, FIG. 5 is a side cross-sectional view of the reflector assembly for a satellite antenna of FIG. 1, and FIG. 6 is a perspective view of a reinforcing member of the reflector assembly for a satellite antenna of FIG. 1.

Referring to FIG. 1 to FIG. 6, the reflector assembly for a satellite antenna 100 includes a reflector 110 having a parabola shape and a reinforcing member 120 coupled to the reflector 110 in order to improve rigidity of the reflector 110 against a stress applied from external impact, or the like.

The reflector 110 is a parabolic reflector used for a general satellite antenna, is a concave reflector having a cone shape (a dish shape) that is cut the end thereof. An antenna hole 111 is formed to penetrated through a center of the reflector 110 for exposing a horn antenna (not shown), or the like. The reflector 110 is made of a first material having low density in view of lightness of the satellite antenna, and the first material is an aluminum material having a light weight and has excellent plastic workability according to the exemplary embodiment of the present invention. In this case, an aluminum material is not only a pure aluminum, but also an alloy including aluminum. However, a material of the reflector 110 is not limited to the aluminum material and also may be other material having a light weight and an excellent plastic workability. A material of a plate shape of the reflector 110 is prepared as a parabola shape through plasticity manufacturing process such as spinning method, or the like. Here, the spinning process is one of the plasticity manufacturing processes, which is a molding method rotating a frame fit into an inner portion of product and the plate shape material by pushing and attaching a bar or a roller to the plate shape material. In the case in a material is difficult to manufacturing according to a material in spinning method, the material may be manufactured by applying heat. The reflector 110 includes a bend part 115 which forms an insertion space by bending an edge thereof outwardly. The bend part 115 is formed at the edge of the reflector 110 in the circumferential direction of the reflector 110. In this case, an outer side of the reflector 110 means a convex part of the reflector and an inner side of the reflector 110 means a concave part of the reflector 110. The reinforcing member 120 is inserted into the insertion space formed by the bend part 115, the detail description thereof will be provided below with the reinforcing member 120.

The bend part 115 may be formed by bending outwardly the edge of the reflector 110. Here, the bend part 115 may be formed at the reflector 110 using the spinning process described in view of the bend part 115 is formed in the circumferential direction of the reflector 110. The bend part 115 as described above has an effect to improving the rigidity of the reflector 115 as itself, however, the rigidity of the reflector 110 may be further improved by coupling with the reinforcing member 120 described below. The reinforcing member 120 is coupled to the edge of the reflector 110 in the circumferential direction of the reflector 110. The reinforcing member 120 is coupled to the edge of the reflector 110 in the circumferential direction of the reflector 110. The reinforcing member 120 is made of a second material having rigidity higher than that of the material of the reflector 110 (the first material), in the exemplary embodiment of the present invention, the second material is a stainless steel having a high rigidity and excellent corrosion resistance. However, the material of the reinforcing member 120 is not limited to the stainless steel, and also may be formed of other material having a high rigidity and an excellent corrosion resistance. In this case, the material of the reinforcing member 120 may be formed of a material having rigidity higher than that of the reflector 110. Further, according to the case, a material (the second material) forming the reinforcing member 120 may be a similar to a material (the second material) of the reflector 110.

In the exemplary embodiment of the present invention, the reinforcing member 120 is prepared by molding a straight pipe having a circular cross-section as a ring shape. At this time, both surfaces of the ring shaped pipe configuring the reinforcing member 120 may be boned to each other by welding process, or the like, in view of securing a required rigidity.

Meanwhile, unlike the exemplary embodiment of the present invention, the reinforcing member 120 may be formed a plurality of the pipes having relative short length and partially disposed on the edge of the reflector 110, however, in this case, the stress applied to the reflector 110 focus on a predetermine portion and a process that the reinforcing member 120 is coupled to the reflector 110 is relatively complex. Therefore, the reinforcing member 120 is prepared a pipe having a ring shape as described in the embodiment of the present invention and may be disposed at the entire edge of the reflector 110.

In addition, the pipe configured the reinforcing member 120 as described in the embodiment of the present invention may have a circular cross-section, whereby it uniformly divides the stress applied to the reflector 110 as compare to the other cross-section shape, further, the process that the bend part 115 is formed on the reflector 110 may relatively performed smoothly.

However, a cross-section of the pipe configured the reinforcing member 120 is not limited to a circular shape. Further, the reinforcing member 120 may be formed a bar shape having no space instead of a pipe, however, the pipe is preferable in view of lightness.

As described above, the reinforcing member 120 is coupled to the bend part 115 by bending outwardly the edge of the reflector 110. More specifically, the reinforcing member 120 is fit to an insertion space formed by the bend part 115 of the reflector 110, and fixedly coupled to the reflector 110. That is, the bend part 115 is bended outwardly such that the edge of the reflector 110 is to cover or enclose the reinforcing member 120 and is fixedly coupled the reflector 110 to the reinforcing member in a clamping method. This coupling method of the reflector 110 and the reinforcing member 120, since the bend part of the reflector 110 encloses the reinforcing member 120, the rigidity of the reflector 110 may further improve according to the integration or complex action of the bend part 115 and the reinforcing member 120. Further, there is no need to a welding process, or the like to fix the reinforcing member 120 to the reflector 110, thereby making it possible to improve the efficiency and productivity of the manufacturing process. For reference, since the reflector 110 and the reinforcing member 120 are made of a different material, a sufficient coupling strength may not be secured when the reinforcing member 120 is coupled to the reflector 110 by welding method.

As described above, the reflector assembly 100 of a satellite antenna according to the present invention, since rigidity of a reflector 110 can be improved without increasing weight of the reflector 110 is not increased (that is, maintaining lightness) by coupling the reinforcing member 120 to an edge of the reflector 110 in the circumferential direction of the reflector 110, deformation of the reflector 110 caused by stress applied to the reflector 110 due to external impact, or the like may be prevented.

Also, according to the exemplary embodiments of the present invention, a bend part 115 is formed at the edge of the reflector 110 and a reinforcing member 120 is coupled to the reflector 110 in a structure which it is enclosed by the bend part 115, thereby making it possible to further increase the rigidity of the reflector 110. In this case, since a welding process, or the like, for bonding the reinforcing member 120 to the reflector 110 is not required, efficiency and productivity of a manufacturing process may be improved.

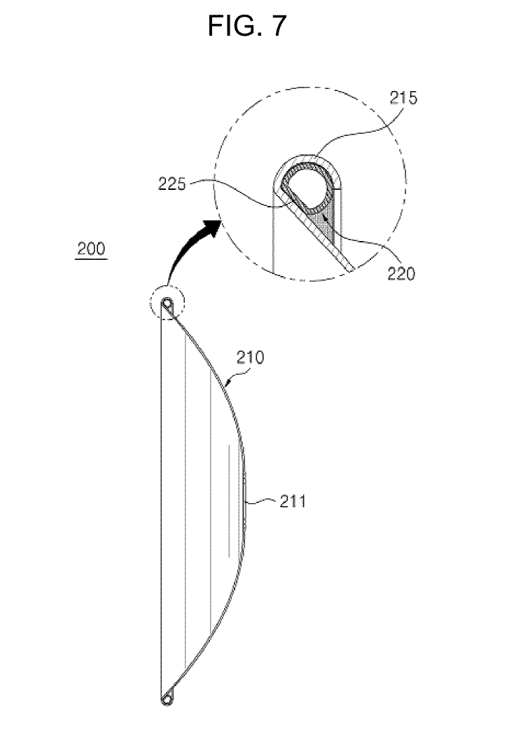

FIG. 7 is a side cross-sectional view of the reflector assembly for a satellite antenna according to another embodiment of the present invention. Hereinafter, the reflector assembly for the satellite antenna according to the exemplary embodiment of the present invention will be described focused on differences from the above mentioned embodiment.

Referring to FIG. 7, the reflector assembly 200 for the satellite antenna includes a reflector 210 having a parabola shape and a reinforcing member 220 coupled to the reflector 210 in order to improve rigidity of the reflector 210 against a stress applied from external impact, or the like.

Since the reflector assembly 200 for the satellite antenna according to the present invention, as compared FIG. 7 with FIG. 5, except for a shape of the reinforcing member 220 and a bend part 215 formed at a reflector 210, is same as a configuration of the reflector assembly 100 for the satellite antenna according to the present invention, above mentioned embodiment is applied to a description about the same configuration.

The reflector 210 is a parabolic reflector used for a general satellite antenna, same as the above mentioned reflector 110, and is a concave reflector having a cone shape (a dish shape) that is cut the end thereof. An antenna hole 210 is formed to penetrated through a center of the reflector 211 for exposing a horn antenna (not shown), or the like.

The reflector 210 includes the bend part 215 forming an insertion space by bending outwardly the edge thereof along the circumference direction. The reinforcing member 220 is inserted into the insertion space formed by the bend part 215. The bend part 215 as described above has an effect to improving the rigidity of the reflector 210 as itself, however, the rigidity of the reflector 210 may be further improved by coupling with the reinforcing member 220.

The reinforcing member 220 is coupled to the edge of the reflector 210 in the circumferential direction of the reflector 210 same as the reinforcing member 120, as above mentioned embodiment. In more detail, the reinforcing member 220 is coupled to the insertion space formed by the bend part 215 and fixed, in a circumferential direction of the reflector 210. However, the reinforcing member 220 is formed in a ring shape pipe as above mentioned embodiment, and a flat part 225 is formed at a pipe in a circumferential direction as shown in an enlarged view of FIG. 7. At this time, the flat part 325 may be formed at a reinforcing member 220 by press-processing one side of the pipe having a circular cross section. That is, the reinforcing member 220 according to the exemplary embodiment of the present invention is different from the reinforcing member 120 having a circular shape as above mentioned embodiment, for example, in view of that it has a ‘D’ letter shape cross-section. As described above, a reason of forming the flat part 225 at the reinforcing member 220 is that the bend part 215 is enclosed the reinforcing member 220 in state in which the bend part 215 is close to the reinforcing member 220 as much as possible, during the process forming the bend part by bending outwardly the edge of the reflector 210. Accordingly, a remaining space between the bend part 215 of the reflector 210 and the reinforcing member 220 is reduced as compared with a remaining space of the bend part 115 of the reflector 110 and the reinforcing member 120(See FIG. 7 and FIG. 5). Therefore, the rigidity of the reflector 210 is increased as compared to the rigidity of the reflector 110 as above mentioned embodiment.

Finally, the reflector assembly 200 for a satellite antenna comprises all advantages of above mentioned embodiment, and a shape of the reinforcing member 220 and a shape of the bend part 215 of the reflector 210 may be changed as described above, thereby making it possible to further improve rigidity of the reflector 210 against stress applied to the reflector 210 due to external impact, or the like.

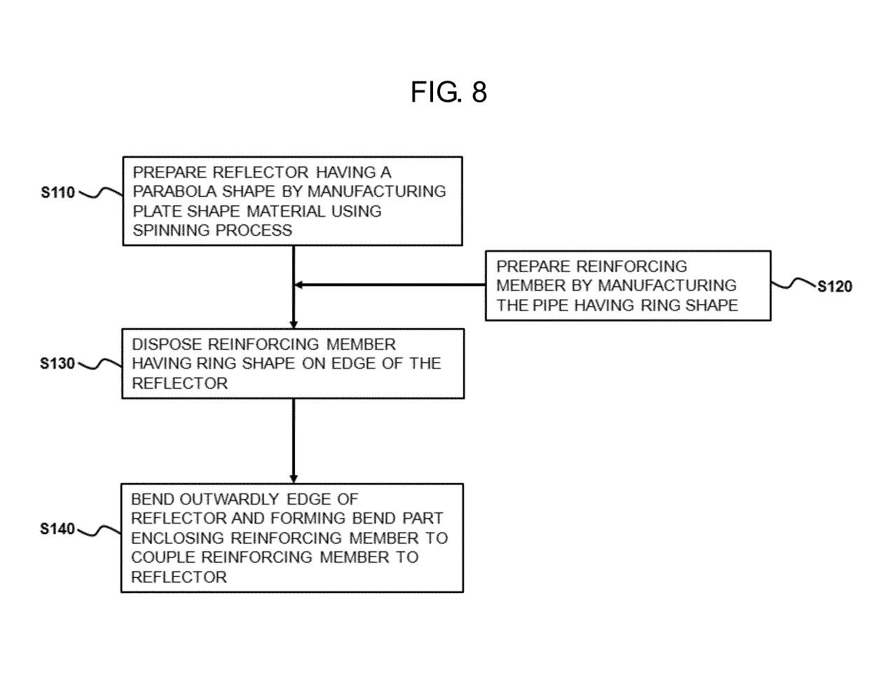

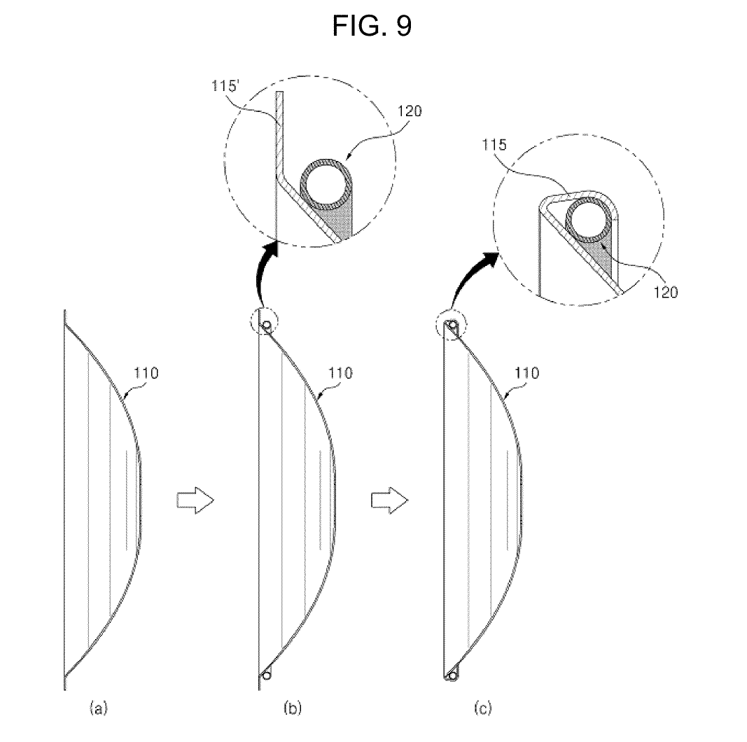

FIG. 8 is a flow chart provided in order to describe an exemplary embodiment of manufacturing method of the reflector assembly for a satellite antenna of FIG. 1, and FIG. 9 is a view schematically showing a process for manufacturing the reflector assembly for a satellite antenna of FIG. 1. Hereinafter, an exemplary embodiment of a process for manufacturing the reflector assembly for a satellite antenna of FIG. 1 will be described. However, an overlapped description with sufficiently described descriptions about the reflector assembly 100 for a satellite antenna of FIG. 1 will be omitted.

Referring to FIGS. 8 and 9, a process for manufacturing the reflector assembly for a satellite antenna according to the present invention includes: preparing the parabola shape reflector 5110, and a reinforcing member having a ring shape S120, disposing a reinforcing member having a ring shape at an outside of an edge of the reflector 5130, and coupling the reinforcing member to the reflector by forming a bend part at the edge of the reflector 5140.

In preparing the reflector having a parabola shape (S110), the reflector 110 having a parabola shape that a plate shape material is formed in a curved surface by spinning process is manufactured (See FIG. 9 (a)).

That is, the step (S110) is performed on a spinning lathe. Otherwise, the reflector 110 having a parabola shape may be manufactured by, a plasticity manufacturing process, for example, a press process using an upper mold or a lower mold other than the spinning process.

In preparing the reinforcing member having a ring shape (S120), the reinforcing member is manufactured by molding a straight pipe having a circular cross section which is made of a stainless steel to a ring shape. This step (S120) is not performed after preparing the reflector having a parabola shape as described above (S110), but is performed before the step (S110) or together.

Next, disposing the reinforcing member having a ring shape at the outside of the edge of the reflector (S130), in order to be coupled the reflector 110 having a parabola shape which is preparing in the previous steps (S110 and S120) to the reinforcing member 120 having a ring shape, a position of the reinforcing member 120 is fixed by disposing the reinforcing member 120 having a ring shape at the edge of the reflector 110 and using an appropriate fixing mean (not shown) (See FIG. 9(b))

Next, in the step of coupling the reinforcing member to the reflector (S140), the bend part 115 is formed to cover or enclose by bending outwardly the edge 115′ of the reflector in the circumferential direction of the reflector 110. (See FIG. 9(c)) Therefore, the reinforcing member 120 is coupled to the bend part 115 of the reflector in a clamping method. This step (S140) is performed at a spinning lathe in view of the bend part 115 is formed along the circumferential direction of the reflector 110. That is, the bend part 115 is formed at a reflector 110 by the spinning process. Otherwise, the bend part 115 may be manufactured by, a plasticity manufacturing process, for example, a press process using an upper mold or a lower mold other than the spinning process. Meanwhile, in the step (S140), the spinning lathe which is used for above mentioned step (S110) may be used.

As described above, a process for manufacturing the reflector assembly for a satellite antenna according to the present invention, since the bend part 115 is formed to cover or enclose by bending outwardly the edge 115′ of the reflector in the circumferential direction of the reflector 110, there is no need to a welding process, or the like to fix the reinforcing member 120 to the reflector 110, thereby making it possible to improve the efficiency and productivity of the manufacturing process.

Particularly, a process for manufacturing the reflector assembly for a satellite antenna according to the present invention, the step of preparing the parabolic shape reflector (S110) and the step of coupling the reinforcing member to the reflector by forming a bend part at the edge of the reflector (S140) are performed by the spinning process, thereby making it possible to improve the efficiency and productivity of the manufacturing process.

According to the present invention is not limited thereto, but those skilled in the art will appreciate that various modifications, additions and substitutions are possible, without departing from the scope and spirit of the invention as disclosed in the accompanying claims. Accordingly, those edited examples or modified examples should be included in the scope of the present invention.

For example, as above mentioned embodiments, in consideration of an advantage, or the like during the spinning process, although the reinforcing members 120 and 220 are disposed on the ‘outside’ of the edge of the reflectors 110 and 210 and the bend parts 115 and 215 are formed by bending outwardly the edge of the reflectors 110 and 210 the reinforcing member is disposed on the ‘inside’ of the edge of the reflector and the bend part of the reflector may be formed by bending inwardly the edge of the reflector.

### INDUSTRIAL APPLICABILITY

The present invention may used for a satellite antenna, or the like.

1. A reflector assembly for a satellite antenna comprising:
a reflector having a parabola shape and made of a first material; and
a reinforcing member disposed at an edge of the reflector in a circumferential direction of the reflector and made of a second material,
wherein the reflector includes a bend part formed by bending an edge of the reflector so as to enclose the reinforcing member to couple the reinforcing member to the reflector.

2. The reflector assembly for a satellite antenna as set forth in claim 1, wherein the second material has rigidity higher than that of the first material.

3. The reflector assembly for a satellite antenna as set forth in claim 2,
wherein the first material is aluminum, and
the second material is stainless steel.

4. The reflector assembly for a satellite antenna as set forth in claim 1,
wherein the reinforcing member is prepared by molding a pipe having a circular cross-section in a ring shape.

5. The reflector assembly for a satellite antenna as set forth in claim 1,
wherein the reinforcing member is formed of a pipe having a ring shape, the pipe being provided with a flat part extended in the circumferential direction.

6. The reflector assembly for a satellite antenna of claim 1,
wherein the bend part fixes the reinforcing member to the reflector in a clamping scheme.

7. A manufacturing method of a reflector assembly for a satellite antenna comprising:
(a) preparing a reflector having a parabola shape;
(b) preparing a reinforcing member in order to improve rigidity of the reflector;
(c) disposing the reinforcing member at an edge of the reflector; and
(d) forming a bend part enclosing the reinforcing member by bending the edge of the reflector so as to couple the reinforcing member to the reflector.

8. The manufacturing method of a reflector assembly for a satellite antenna as set forth in claim 7, wherein in step (b),
the reinforcing member is prepared by molding a pipe having a circular cross-section.

9. The manufacturing method of a reflector assembly for a satellite antenna as set forth in claim 7, wherein in step (b),
the reinforcing member is formed of a pipe having a ring shape, the pipe being provided with a flat part extended in a circumference direction and formed by press processing.

10. The manufacturing method of a reflector assembly for a satellite antenna of claim 7, wherein in step (d),
the bend part is formed in the circumference direction of the reflector by bending the edge of the reflector outwardly by spinning processing.

11. The manufacturing method of a reflector assembly for a satellite antenna of claim 7,
wherein the reflector is made of an aluminum material, and
the reinforcing member is made of stainless steel having rigidity higher than that of the reflector.
